(19) United States
(12) Patent Application Publication
(10) Pub. No.: US 2012/0048212 A1
(43) Pub. Date: Mar. 1, 2012

(54) Canine Barking Suppression Device

(76) Inventor: Deonisy Konovalov, Molalla, OR (US)

(21) Appl. No.: 12/868,674

(22) Filed: Aug. 25, 2010

(51) Int. Cl. A01K 15/02

(52) U.S. Cl. 119/718; 119/719

(57) ABSTRACT

A non powered, canine barking suppression device that can rapidly altering a dog's behavior so as to visibly reduce anxiousness and unwanted barking. The device subjects the dog to random vibrations and audible tones generated by an enclosed tuning fork that is worn around the dog's neck. The tuning forks when struck, emit a selected frequency selected for a specific purpose and or specific breed of canine. This frequency lies between 0 and 200,000 Hz, which is the range of sound that has been shown that most canines can hear. Since it is non powered it is not prone to failure in wet or cold environments, is durable and inexpensive. The device has claims of additional therapeutic properties and the general physical structure has applications elsewhere, although the preferred embodiment and best mode are directed to stopping unnecessary barking.

### BACKGROUND OF THE INVENTION

The present invention relates to a new and improved canine barking suppression device capable of rapidly altering a dog's behavior so as to visibly reduce their anxiousness, calm the dog and drastically reduce their barking.

There are several systems utilized to calm an anxious dog or to stop needless, annoying barking. To date, these systems all work by subjecting the dog to an unpleasant stimuli at the time of the bark initiation. These may be in the form of a high voltage electric shock applied to the dog's neck or a puff of disagreeably smelling aerosol expelled in close proximity to the dog's nose. They require expensive systems and a DC power source to operate. In rain or water they malfunction and may fail permanently. Lastly, many owners feel that such systems of canine behavior modification are cruel, and while needed will not likely be purchased or used by them.

Henceforth, a non powered interactive canine barking suppression system that not hurt the dog, would not fail in wet or cold environments and would be durable and inexpensive, would fulfill a long felt need in the field of canine behavior modification. This new invention utilizes and combines known and new technologies in a unique and novel configuration to overcome the aforementioned problems and accomplish this.

### SUMMARY OF THE INVENTION

The general purpose of the present invention, which will be described subsequently in greater detail, is to provide a non-powered, economical, durable, canine behavior modification device that is not hurtful to a dog. In addition, to providing dog behavior modification such as cessation of barking the present invention has claims of additional therapeutic properties and the general physical structure has applications elsewhere, although the preferred embodiment and best mode are tied to stopping unnecessary barking.

It has many of the advantages mentioned heretofore and many novel features that result in a new and improved canine bark suppression system which is not anticipated, rendered obvious, suggested, or even implied by any of the prior art, either alone or in any combination thereof.

In accordance with the invention, an object of the present invention is to provide an improved interactive non-powered, canine bark suppression device capable of rapid correction of unnecessary barking.

It is another object of this invention to provide an improved canine bark suppression device that is durable and will not fail in adverse weather conditions or if immersed underwater.

It is a further object of this invention to provide an improved canine bark suppression device that is inexpensive to produce and has an extremely low failure rate.

It is still a further object of this invention to provide an improved canine bark suppression device that has additional therapeutic qualities.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements. Other objects, features and aspects of the present invention are discussed in greater detail below.

### BRIEF DESCRIPTION OF THE DRAWINGS

FIG. 1 is a front perspective view of the interior cavity of the canine bark suppression device showing the general arrangement of the components in the preferred embodiment;

FIG. 2 is a front perspective view of the interior cavity of the canine bark suppression device showing the general arrangement of the components in the first alternate embodiment;

FIG. 3 is a front perspective view of the interior cavity of the canine bark suppression device showing the general arrangement of the components in the second alternate embodiment;

FIG. 4 is a front perspective view of the interior cavity of the canine bark suppression device showing the general arrangement of the components in the third alternate embodiment;

FIG. 5 is a front perspective view of the interior cavity of the canine bark suppression device showing the general arrangement of the components in the fourth alternate embodiment;

FIG. 6 is a front perspective view of the canine bark suppression device's enclosure; and

FIG. 7 is an interior front perspective view of a fifth alternate embodiment;

FIG. 8 is a exterior front perspective view of a fifth alternate embodiment; and

FIG. 9 is a cross sectional front perspective view of a sixth alternate embodiment.

### DETAILED DESCRIPTION

There has thus been outlined, rather broadly, the more important features of the canine bark suppression device in order that the detailed description thereof that follows may be better understood and in order that the present contribution to the art may be better appreciated. There are, of course, additional features of the invention that will be described hereinafter and which will form the subject matter of the claims appended hereto.

In this respect, before explaining at least one embodiment of the canine bark suppression device in detail, it is to be understood that the invention is not limited in its application to the details of construction and to the arrangements of the components set forth in the following description or illustrated in the drawings. The invention is capable of other embodiments and of being practiced and carried out in various ways. For example, although throughout the alert fob is associated with a key ring and the alert card is associated with the wallet, it is known that these alert devices may be physically connected to other items such as an MP3 player, an article of clothing, a camera, etc. Also, it is to be understood that the phraseology and terminology employed herein are for the purpose of descriptions and should not be regarded as limiting.

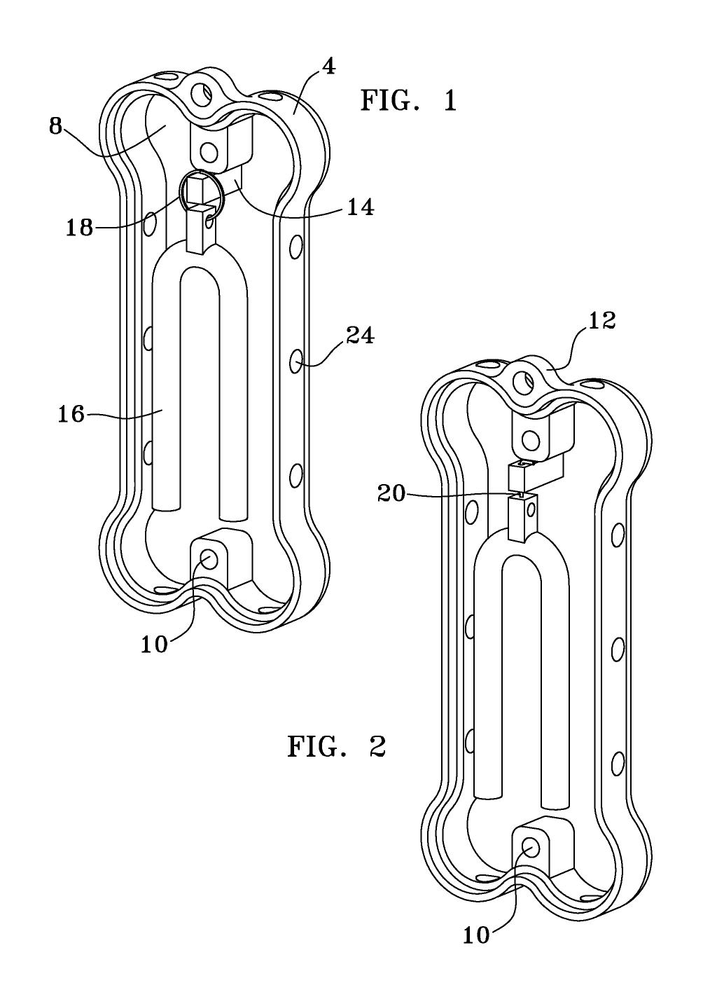

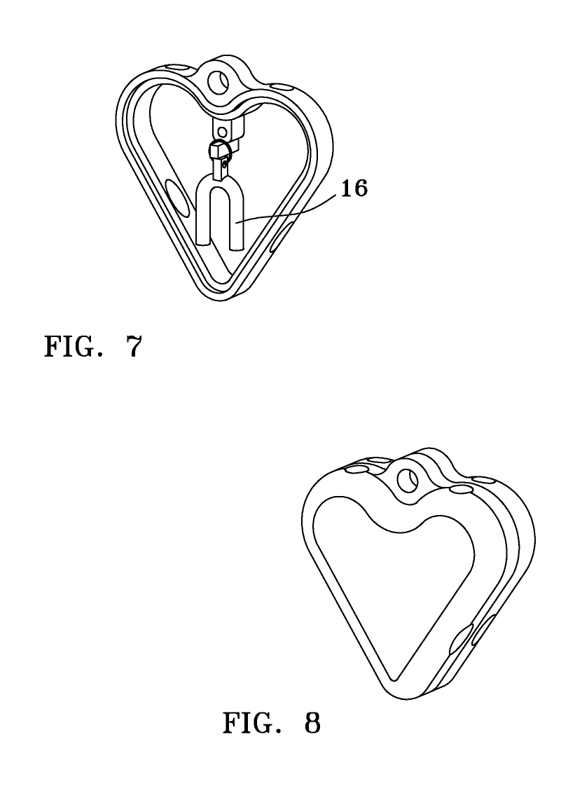

Looking at FIGS. 1 and 6 it can be seen that the improved canine bark suppression device 2 has the general shape of a dog bone made from the assembly of a concave first half 4 and a concave second half 6. In the concavity 8 of the first half 4 there is formed on the inner surface two bosses 10 that are matingly threaded to accept taper headed screws 12 that extend from the surface of the second half 6 and through an orifice in the second half so as to facilitate the mechanically coupling of the two halves. It is known that there area plethora of additional methods of connecting these two halves as would be well known in the art. The periphery of the assembled device 2 has numerous ports 24 formed there through to allow enhanced transmission of the audible frequency emitted from within the internal cavity of the device 2. The device 2 has a hanging tab 12 extending from the exterior surface of the device 2. This tab allows for the attachment of the device 2 to a dog collar, clothing or leash. As can be seen in FIG. 1 and FIG. 3, this tab 12 may cause the device to hang with its longitudinal axis in a horizontal or vertical orientation. The location of the hanging tab 12 determines the orientation of the internal components of the device 2. (It is to be noted that the designation of first and second half is of no consequence as any of the internal components can be interchangeably connected to or formed on either of these halves.)

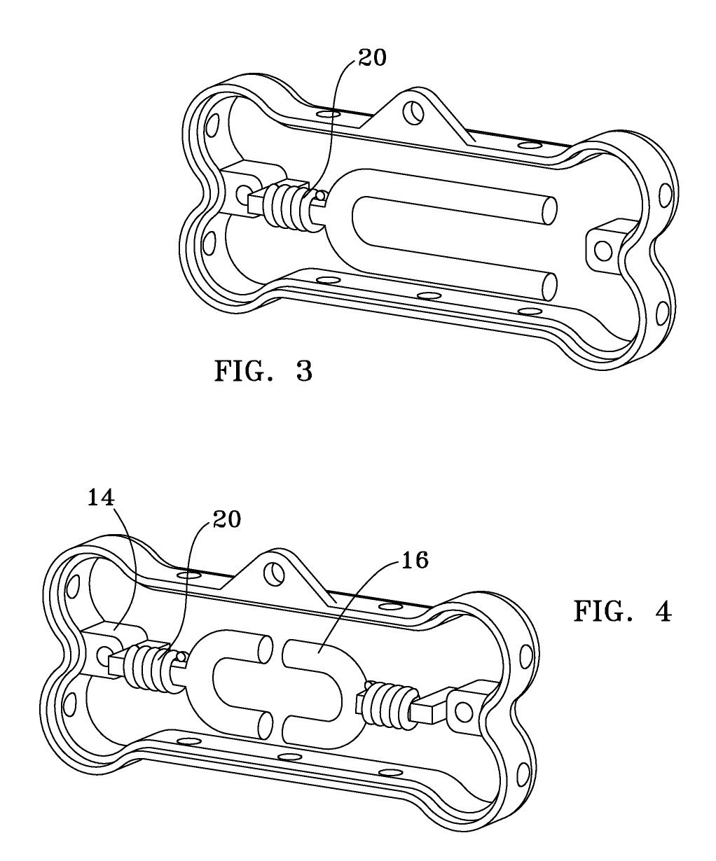

Looking at FIG. 1 it can be seen that there is a mounting means 14 extending from the internal surface of the device's cavity from which an audible frequency generator or tuning fork 16 is operationally connected. Although a tuning fork 16 is shown in all the figures a tuning rod has also been employed successfully as an audible frequency generator. In the preferred embodiment the tuning fork 16 is freely connected to the mounting means 14 by a suspension means 18. Here the suspension means is a ring. In FIG. 2 the first alternate embodiment the suspension means is a longitudinal member which is a wire 20. In FIG. 3 the second alternate embodiment it can be seen that the suspension means is a wound spring. There are numerous type of suspension means 20 that will work including but not limited to wires, springs, string, cable, pivotable rods, link chains etc.

The suspension means 20 serves to hold the tuning fork 16 away from the inside of the device 2 or away from the striking means 22 when the device is in its resting or non-jostled position. It may serve to hold the tuning fork 16 rigid in embodiments where there is a striking means 22 that moves to collide with the tuning fork 16 or it may allow the tunning fork to swing freely to contact a striking means 20 or the inside of the device itself in other embodiments.

The suspension means 20 generally will have a distal end and a proximate end wherein one of these ends is connected to the mounting means 14 and the other end is connected to the tuning fork 16. As can be seen in FIGS. 1 and 2 the device 2 has the hanging tab 12 located such that the device 2 will be oriented vertically when on the dog. Here the suspension means (ring and wire) 20 allows the tuning fork 16 to freely swing as the device 2 is jostled with the dog's movements, such as is caused by barking. This causes the tuning fork 16 to strike the inside of the device 2 causing the tuning fork to vibrate at its specific frequency emitting that frequency of sound and vibration. This emitted sound traverses through the ports 24 to the dog's ears. Experimentation has shown that using a tuning fork that has a frequency up to 200,000 Hz will reduce the dog's desire to bark and generally calm him. The vibrations caused by the tuning fork

are also reported to have therapeutic effects such as flea riddance, toxic riddance, increasing blood flow, and simulating blood cells.

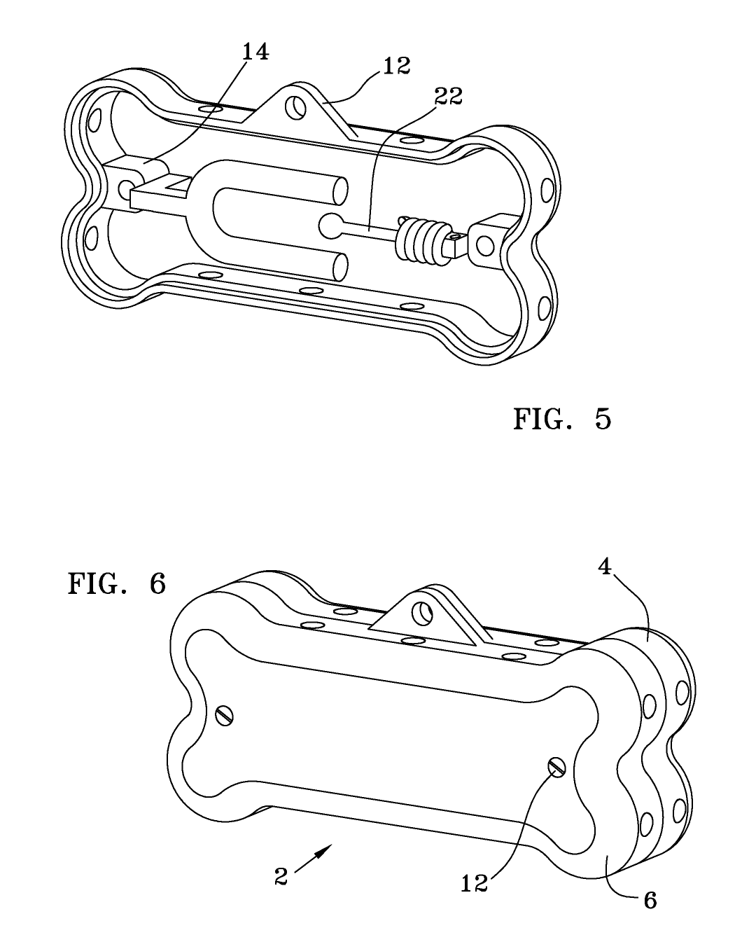

As can be seen in FIGS. 3 and 4 the device 2 has the hanging tab 12 located such that the device 2 will be oriented horizontally when on the dog. Here the suspension means 20 allows the tuning fork 16 to be suspended within the cavity and upon overcoming a certain amount of jostling motion will allow the tuning fork 16 to swing enough to have a collision and then return to its suspended position so as to maintain the tuning fork's vibration. When the tuning fork 16 is in continued contact with any physical body there can be no vibration of the tuning fork 16.

FIG. 4 shows a third alternate embodiment that employs the same basic structure and operation as the previous devices 2 except that it utilizes more than one tuning fork 16 and suspension means 20 and mounting means 14.

In the fourth alternate embodiment shown in FIG. 5 it can be seen that the tuning fork 16 is rigidly held in a mounting block 14 and a striking means 22 is moveably mounted in another mounting block 14. In this embodiment the striking means 22 is jostled by the dog's movements to collide with and begin the vibration and resonation of the tuning fork 16. When struck the tunning fork 16 will resonate at a frequency (with a decreasing amplitude and volume) that is less than 200,000 Hz. This is the complete range of audible frequencies in the hearing range of most canines.

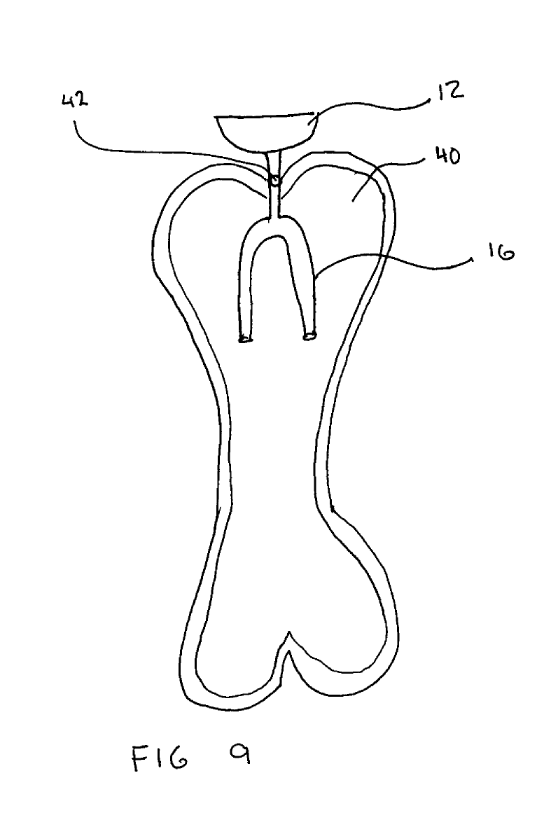

FIGS. 7 and 8 illustrate another physical geometry of the enclosure of the device 2 made from the assembly of the concave first half 4 and concave second half 6. Here it is a heart. Such shapes in different sizes would also allow a pendant, necklace or set of earrings to be fabricated for therapeutic use in humans. Similarly such a device 2 could be hung from a vehicle's interior possibly from the rear view mirror or added to a key chain. It is also envisioned that a plethora of such devices could be assembled into a hanging mobile or wind chime arrangement.

FIG. 9 shows a sixth alternate embodiment wherein the audible frequency generator 16 (whether a tuning fork, tuning rod tube or equivalent device) is held rigid to the hanging tab 12 and a modified hollow enclosure 40 is operably connected to said hanging tab 12 by a pin 42 so as to allow it to move and strike the audible frequency generator 16. This is almost the reverse principle of operation of the above mentioned embodiments.

In the embodiments discussed it is intended that the device 2 would be waterproof in the meaning of the word that immersion in water will not have any detrimental effects on the device 2. The majority of the components of the preferred embodiment are made of a stainless steel, aluminum, bronze brass or other non water corrodable metal or metal alloy. The choice of a material for the two halves must be resilient yet rigid to transmit the overtones resonating from the vibrating tuning fork. The size of the ports may be adjusted to increase or dampen the emitted sound.

The above description will enable any person skilled in the art to make and use this invention. It also sets forth the best modes for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Having thus described the invention, what is claimed as new and desired to be secured by Letters Patent is as follows:

1. A bark suppression device comprising:
a ported rigid waterproof enclosure;
at least one suspension mount;
at least one suspension means having a distal end and a proximate end;
at least one non powered audible frequency generator;
wherein said suspension mount is affixed to an inside surface of said enclosure, and said proximate end of said suspension means is affixed to said suspension mount and said distal end of said suspension means is affixed to said audible frequency generator.

2. The bark suppression device of claim 1 wherein said non powered audible frequency generator is a tunning fork.

3. The bark suppression device of claim 2 wherein said non powered audible frequency generator resonates with a frequency up to 200,000 Hz after colliding with an inside surface of said enclosure.

4. The bark suppression device of claim 3 further comprising a hanging tab that extends from an outer surface of said enclosure.

5. The bark suppression device of claim 5 wherein said distal end of said suspension means is moveable within said enclosure so as to enable said audible frequency generator to strike said inside surface of enclosure when enclosure is jostled.

6. The bark suppression device of claim 5 wherein said suspension means is a wound spring.

7. The bark suppression device of claim 5 wherein said suspension means is a linear attachment member selected from the group of linear attachment members consisting of string, wire, stretch cords, linked chain, wound springs and pivotable shafts.

8. The bark suppression device of claim 7 wherein said ports are orifices formed between an outer surface and an inner cavity of said enclosure.

9. The bark suppression device of claim 8 wherein the number of suspension mounts is two, the number of suspension means is two and the number of audible frequency generators is two.

10. A bark suppression device comprising:
a rigid waterproof enclosure;
at least one suspension mount;
at least one non powered audible frequency generator;
at least one audible frequency generator striking means; and
at least one suspension means having a distal end and a proximate end;
wherein said suspension mount is affixed to an inside surface of said enclosure, and said audible frequency generator is mounted to a first suspension mount, and wherein said striking means is operationally connected by said suspension means to a second suspension mount, and wherein said striking means is within a contacting distance of said audible frequency generator.

11. The bark suppression device of claim 10 wherein said tuning fork is rigidly affixed to said first suspension mount and said striking means is non-rigidly connected to said second suspension mount.

12. The bark suppression device of claim 11 wherein said non powered audible frequency generator is a tunning fork.

13. The bark suppression device of claim 12 wherein said tuning fork resonates with a frequency up to 200,000 Hz after colliding with said striking means.

14. The bark suppression device of claim 13 further comprising a hanging tab that extends from an outer surface of said enclosure.

15. The bark suppression device of claim 14 wherein said striking means is non-rigidly connected to said second suspension mount by said suspension means selected from the group of suspension means consisting of string, wire, stretch cords, linked chain, wound springs and pivotable shafts such that said striking means is moveable within said enclosure so as to enable collisions with said audible frequency generator.

16. The bark suppression device of claim 15 further comprising at least one orifice formed between an outer surface and an inner cavity of said enclosure.

17. The bark suppression device of claim 16 wherein said enclosure has a concave first half and a concave second half that matingly engage to form an internal cavity within said enclosure.

18. The bark suppression device of claim 1 wherein said non powered audible frequency generator is a tunning rod.

19. A bark suppression device comprising:
a rigid waterproof enclosure;
at least one suspension mount;
at least one non powered audible frequency generator;
at least one suspension means having a distal end and a proximate end; and
one hanging tab;
wherein said non powered audible frequency generator is rigidly coupled to said hanging tab and said rigid enclosure is moveably suspended about said audible frequency generator from said hanging tab so that said audible frequency generator resides within a cavity inside said rigid enclosure so as to be able to contact said audible frequency generator when said device is jostled by a canine wearing said device.
